(19) United States
(12) Patent Application Publication
(10) Pub. No.: US 2025/0243927 A1
(43) Pub. Date: Jul. 31, 2025

(54) GEARBOX HEAT SINK OIL FUNNEL

(71) Applicant: DANA ITALIA S.R.L., Arco, Trentino (IT)

(72) Inventors: Andrea BORTOLI, Rovereto (IT); Marco SCOPESI, Isera (IT); Davide DEIMICHEI, Ala (Trento) (IT); Gianluca TERRASI, Arco (IT)

(21) Appl. No.: 18/999,715

(22) Filed: Dec. 23, 2024

Related U.S. Application Data
(60) Provisional application No. 63/626,948, filed on Jan. 30, 2024.

(51) Int. Cl. F16H 57/04; B60K 17/16; B60K 17/28

(52) U.S. Cl. CPC F16H 57/0417; B60K 17/16; B60K 17/28; F16H 57/0423

(57) ABSTRACT

A system for cooling a power take-off (PTO) unit, comprising: a heat sink positioned in a lubricant sump of the PTO unit, the lubricant sump of the PTO unit fluidly coupled to an internal space of an axle; a lubricant funnel positioned to direct lubricant to the heat sink; and a baffle positioned adjacent a rotating gear of the PTO unit and configured to direct lubricant to the lubricant funnel.

### CROSS REFERENCE TO RELATED APPLICATION

The present application claims priority to U.S. Provisional Application No. 63/626,948, entitled “GEARBOX HEAT SINK OIL FUNNEL”, and filed on Jan. 30, 2024. The entire contents of the above-listed application are hereby incorporated by reference for all purposes.

### BACKGROUND AND SUMMARY

Vehicles may have work implements, driven by movers and auxiliary gear sets and/or other ratios of transmission(s). Such vehicles may include off-highway work vehicles, such as straddle carriers, forklifts, tractors, and some construction vehicles. Such vehicles may include on-highway vehicles, such as semi-trucks, utility vehicles, and some construction vehicles. Vehicles with work implements may be electrified. For example, an electrified vehicle with a work implement may be an all-electric vehicle (EVs). For another example, an electrified vehicle may be a hybrid vehicle with multiple sources of torque from electric machines and non-electric motors, such as internal combustion engines (ICEs). Additionally, a vehicle may integrate a power take-off (PTO) system to transfer mechanically energy from a vehicle to operate and effect a work implement. The PTO system and work implement may be used for a plurality of purposes, such as to power and drive a driven device, referred to herein as a PTO device. The PTO device may include a pump, a blower, an air conditioning (AC) unit, a generator, a drill, or another rotational element. Vehicles may incorporate a PTO in the transmission. The PTO system may be driven by a mover. The mover may be an electric machine and may operate as an electric motor. The vehicle may have a plurality of electric machines that may each act as a mover.

In some scenarios, the PTO of a work vehicle may utilize the full power of the work vehicle while the work vehicle is not driving in a direction (e.g., standing still). In some configurations, the PTO is attached to the axle but is not in fluid communication with the axle. Heat dissipation to the PTO and lubrication when not in fluid communication with the axle may be challenging. There is a desire to increase heat dissipation.

In an example, an apparatus is proposed to increase the speed at which oil is passed through a conductive plate between the internal part of a PTO gearbox and an internal part of an axle. This may be accomplished by an oil baffle arranged around a gear forcing the oil to pass through a larger oil baffle assembly while contacting and coating the conductive plate and a plurality of heat exchange elements thermally coupled thereto.

The inventors have herein proposed a system for cooling a power take-off (PTO) unit comprises: a heat sink positioned in an oil sump of the PTO unit, the oil sump of the PTO unit fluidly coupled to an internal space of an axle; an oil funnel positioned to direct oil to the heat sink; and a baffle positioned adjacent a rotating gear of the PTO unit and configured to direct oil to the oil funnel.

In this way, it is possible to exploit oil splashing introduced by gears to increase the speed of the oil passing through a conductive plate between (e.g., the internal part of the PTO gearbox and the internal part of the axle). The oil baffle may partially cover the fins of a heat exchanger; thus the baffle may force the oil flow to pass through the conductive plate. In this manner, the increased speed of the oil moving around the heat exchanger increases the overall heat exchange coefficient, allowing the heat sink to transmit more heat. Further, the transmission is able to transmit more power through the PTO during operation of the PTO, compared to when the oil baffle is not used. In an example, in this way the inclusion of the baffle is also to provide a system with reduced maintenance, as there is a reduction of the moving parts to provide heat exchange to and transport the oil. Operations of the PTO include the transfer of rotational energy via torque through the PTO.

In another representation, the disclosure also provides support for a method of removing thermal energy from a PTO assembly, comprising: splashing lubricant of a first temperature from a gear to a baffle adjacent to the gear, accumulating the lubricant on surfaces of the baffle, directing lubricant passively from the baffle to a funnel, directing lubricant passively from the funnel to a heat exchanger, where the heat exchanger is arranged to extend between the PTO assembly and an internal space housed by an axle assembly, coating a plurality of heat exchange elements of the PTO assembly with lubricant, up-taking thermal energy from the lubricant via conduction, and directing thermal energy from the lubricant across the heat exchanger between the heat exchange elements and a plurality of other heat exchange elements. In a first example of the method comprises: directing lubricant of a second temperature passively toward the other heat exchange elements, and coating the other heat exchange elements with lubricant of the second temperature. In a second example of the method, optionally including the first example comprises using oil as lubricant.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of a drive train of a vehicle.

FIG. 2 shows a schematic diagram of transmission and drive system, which may be part of the drive train of FIG. 1.

FIG. 3 shows a sectional view a PTO assembly of a PTO.

FIG. 4 shows the sectional view of FIG. 3 with a lubricant and a flow path.

FIG. 5 shows a sectional view of the PTO assembly and an axle assembly.

FIG. 6 shows a sectional view of the axle assembly.

FIG. 7 shows a side view of a heat exchanger of the PTO assembly and the axle assembly.

FIG. 8 shows a side view of the heat exchanger.

### DETAILED DESCRIPTION

The following description relates to systems of an auxiliary device of an auxiliary system. The auxiliary system is a power take-off (PTO) system, referred to herein as a PTO unit. The PTO unit may drive a PTO device via an implement. PTO devices may include devices such as a pump, a blower, an air conditioning (AC) unit, a generator, a drill, or another rotational element. The PTO device may be driven when selectively coupled to a plurality of a rotational elements of the PTO unit via an optional disconnect. As an example, the optional disconnect may be a simple disconnect. As another example, the optional disconnect may be a clutch.

The transmission gear train may be a single speed transmission or a multiple speed transmission, such as a two speed transmission. The transmission may be a powershift, a powersplit, and/or a hydrostatic transmission. The transmission may be powered by a mover, such as an electric motor, engine, and/or combinations thereof.

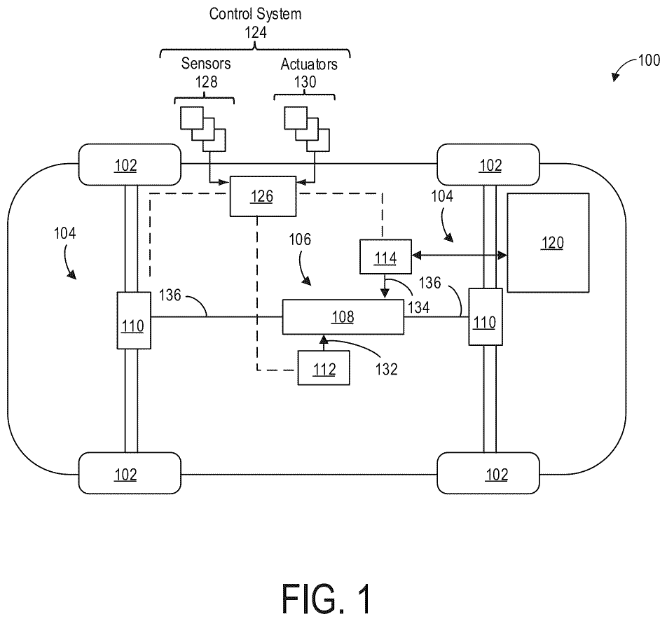

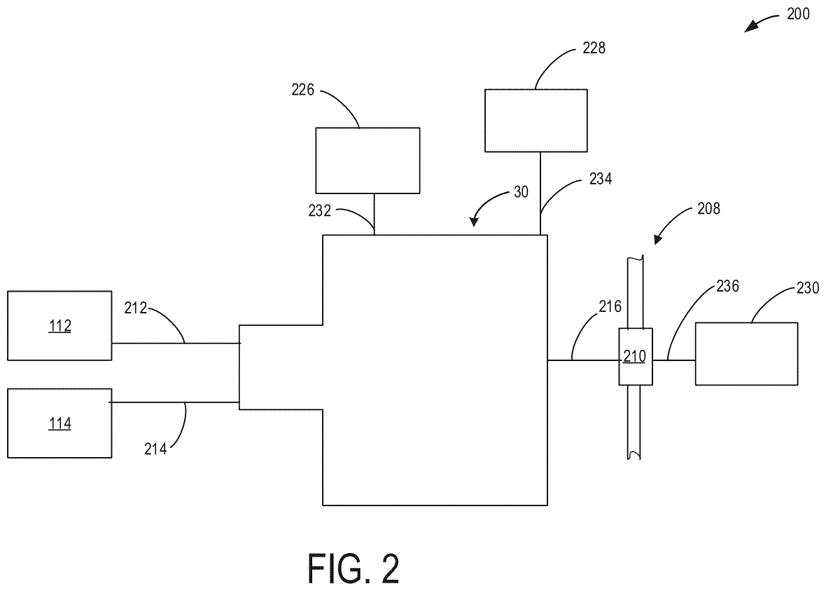

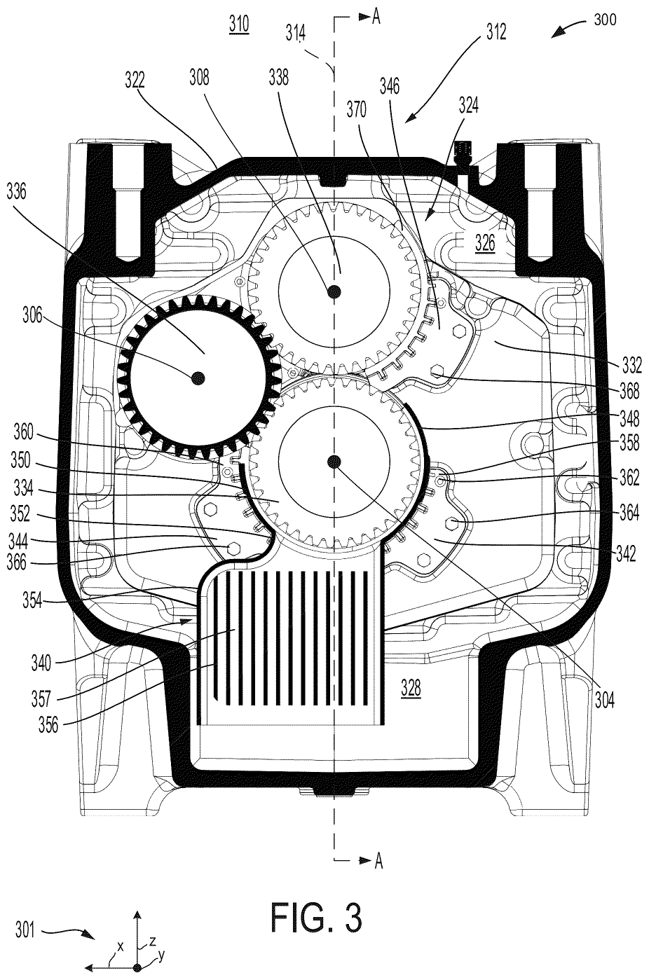

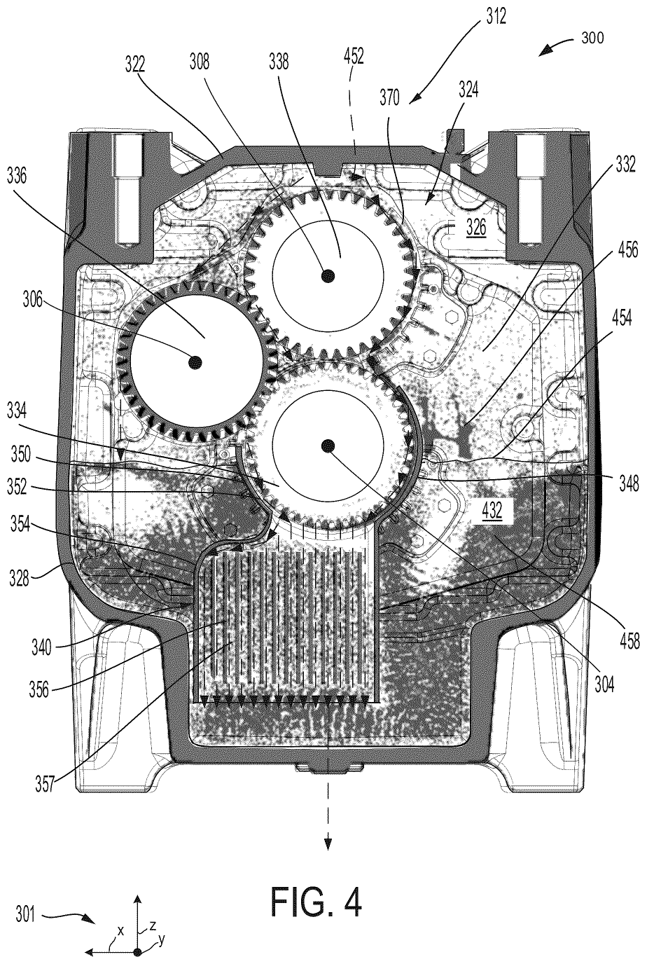

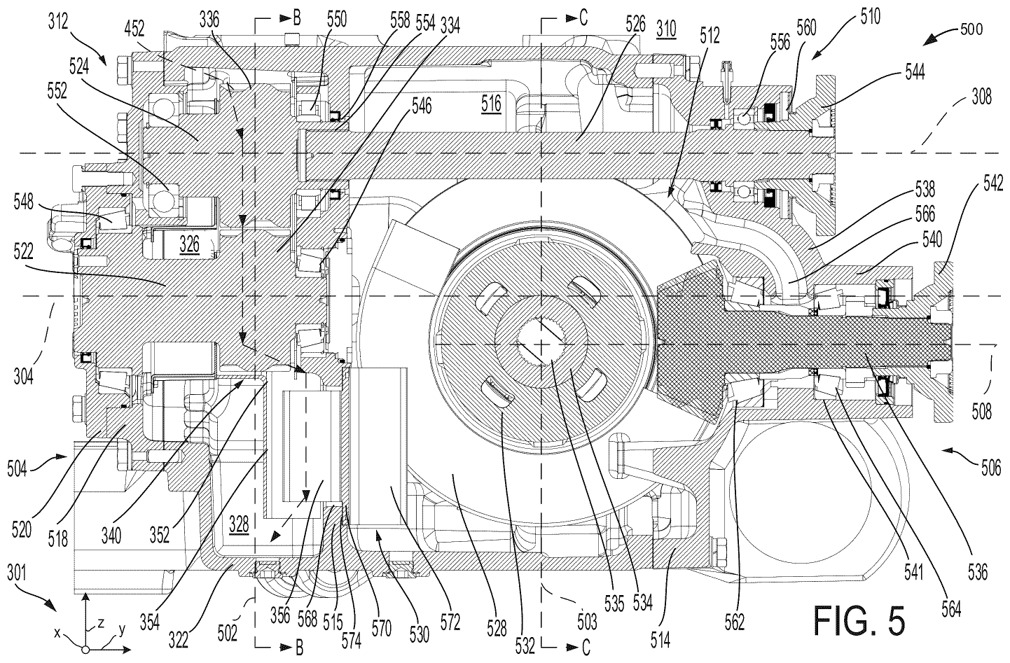

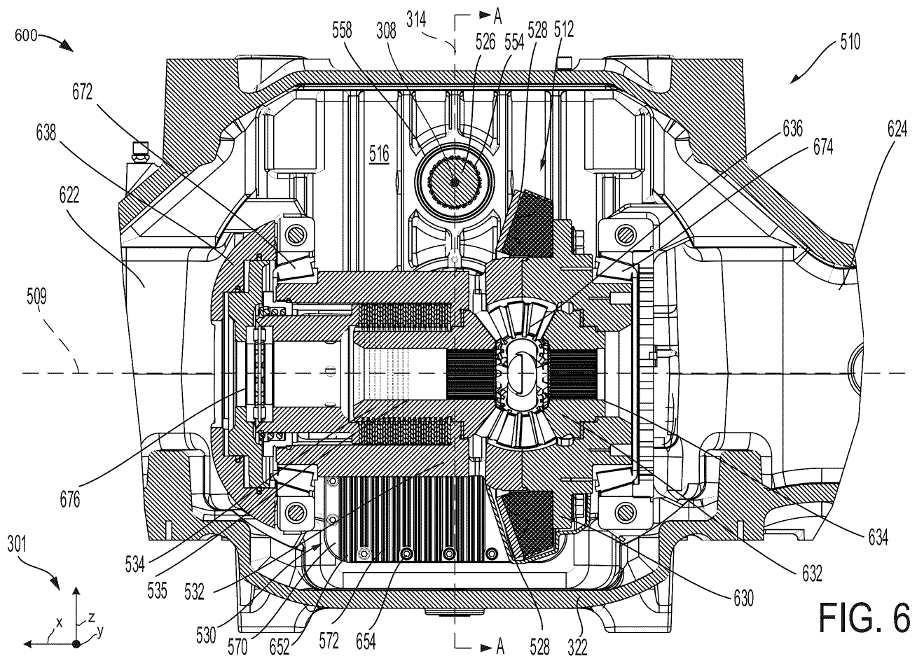

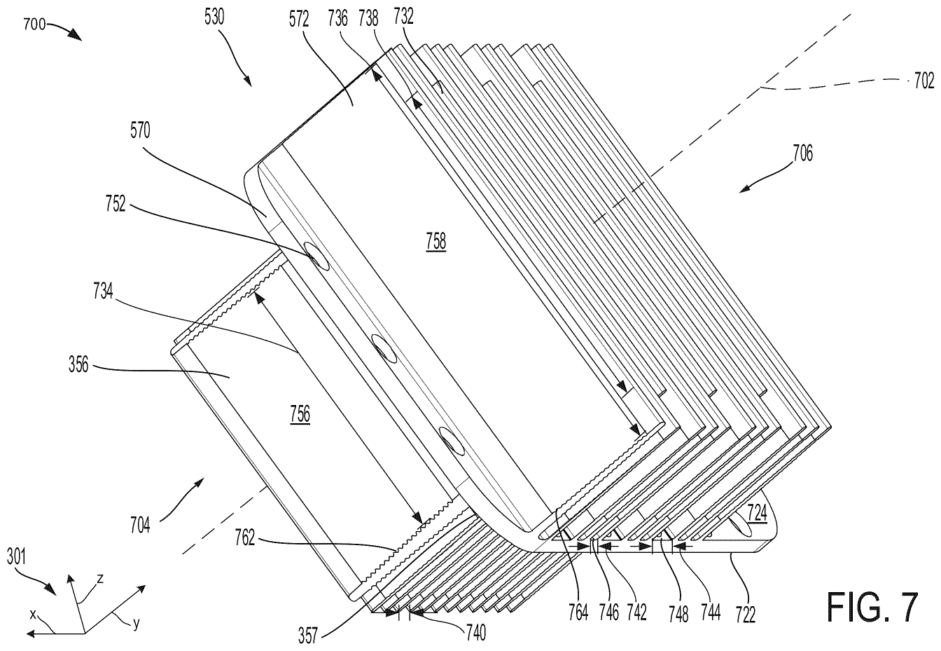

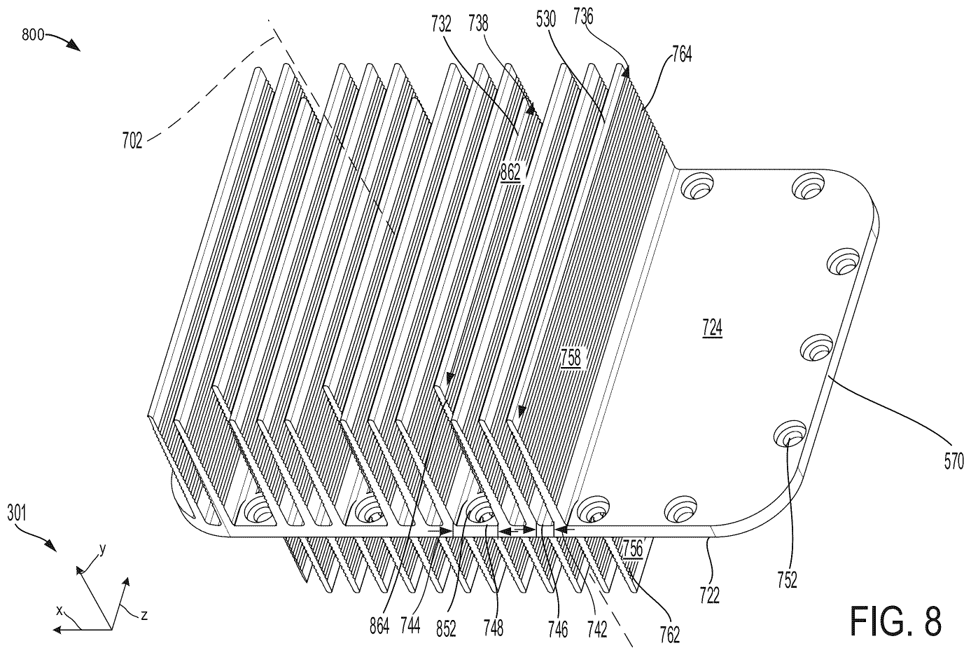

FIG. 1 shows a schematic diagram of a drive train of a vehicle. A PTO device of the use case that may be included by the drive train of the vehicle. FIG. 2 shows a schematic diagram of a transmission and a drive system, which may be part of the drive train of FIG. 1. At least a PTO device of the use-case may be output to by a mover and/or the transmission of the drive in FIG. 2. FIG. 3 shows a sectional view of a PTO assembly. The PTO assembly of FIG. 3 may be part of a use-case PTO. FIG. 3 shows a sectional view a PTO assembly of a PTO. FIG. 4 shows the sectional view of FIG. 3 with a lubricant and a flow path. FIG. 5 shows a sectional view of the PTO assembly and an axle assembly. FIG. 6 shows a sectional view of the axle assembly. FIG. 7 shows a side view of a heat exchanger of the PTO assembly and the axle assembly. FIG. 8 shows a side view of the heat exchanger.

FIGS. 1-2 show schematics of example configurations with relative positioning of the various components. FIGS. 3-7 show example configurations with approximate position. FIGS. 3-7 are shown approximately to scale; though other relative dimensions may be used. As used herein, the terms “approximately” is construed to mean plus or minus five percent of the range unless otherwise specified.

Further, FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to the longitudinal axis. Features described as lateral may be approximately parallel with the lateral axis and normal to the longitudinal axis. Turning now to FIG. 1, a schematic representation of a vehicle 100 is depicted. The vehicle 100 which includes sets of wheels 102 coupled by axles 104 (e.g., pairs of wheels are coupled to one another by the axles 104). It will be appreciated that vehicle 100 is shown in FIG. 1 for illustrative purposes and is a non-limiting example of how an HEV may be configured. Other examples include various arrangements and positioning of components of the vehicle described below as well as additional components not shown in FIG. 1 for brevity.

A drive train 106 of vehicle 100 may include a transmission 108 (e.g., a gear box, gear train, etc.) coupled to one or more of the axles 104 of vehicle 100 via one or more driveshafts 136. The transmission 108 may be coupled to a rear axle via a rear driveshaft and a front axle via a front driveshaft, as shown in FIG. 1, or to one of the front axle and the rear axle, in other examples. The transmission 108 may be mechanically coupled via the driveshafts 136 to a final drive 110 positioned in each of the axles 104 of the drive train 106 which, for example, may be a differential or any other suitable gearing. The transmission 108 and final drive 110 may together translate speed and torque from a rotating source to the vehicle wheels 102 to propel vehicle 100. The present configuration includes a first transmission input shaft 132 coupling an engine 112 and the transmission 108. Additionally or alternatively, the present configuration may include second transmission input shaft 134 coupling an electric machine 114 and the transmission 108. The vehicle 100 may have a plurality of electric machines each with inputs to the transmission 108, where there may be one or more electric machines in addition to the electric machine 114.

When configured as an HEV, the rotating sources may include the engine 112 and the electric machine 114. The engine 112 may be an internal combustion engine (ICE) or another element which may provide rotational power to the transmission shaft. In some examples, and as described herein, the electric machine 114 may be a motor and/or generator, with a capacity to convert electrical energy into mechanical energy and vice versa. As such, the electric machines may hereafter also be referred to as motors and/or generators. The electric machine 114 may be electrically coupled to a traction battery 120 of vehicle 100 to both draw power from the traction battery 120 and provide electrical energy to be stored at the traction battery 120. For example, the traction battery 120 may be a high-voltage battery. In some embodiments, the traction battery 120 may be a generic DC-supply, such as a fuel cell or other power supply. The electric machines may be similarly configured, e.g., having similar operational speed and torque ranges, and thereby referred to as symmetric, or may have different speed and torque outputs, thereby referred to as asymmetric.

Adjustment of the drive train between the various modes, as well as control of operations within each mode, may be executed based on a vehicle control system 124, including a controller 126, as shown in FIG. 1. Controller 126 may be a microcomputer, including elements such as a microprocessor unit, input/output ports, an electronic storage medium for storing instructions, executable programs, and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 126 may be a powertrain control module (PCM).

Controller 126 may receive various signals from sensors 128 coupled to various regions of vehicle 100. For example, the sensors 128 may include sensors at the engine 112 to measure engine speed, engine temperature, and engine pressure; additionally, sensors at the electric machine 114 to measure motor speed and motor temperature, a pedal position sensor to detect a depression of an operator-actuated pedal, such as an accelerator pedal or a brake pedal, speed sensors at the vehicle wheels 102, and so on. Vehicle acceleration is directly proportional to accelerator pedal position, for example, degree of depression. Upon receiving the signals from the various sensors 128 of FIG. 1, controller 126 processes the received signals, and employs various actuators 130 of vehicle 100 to adjust drive train operations based on the received signals and instructions stored on the memory of controller 126. For example, controller 126 may receive an indication of depression of the brake pedal, signaling a desire for decreased vehicle speed. In response, the controller 126 may command operation of at least one of the electric machines, such as the electric machine 114, as a generator to recharge the traction battery 120.

A schematic of a drive 200 shown by FIG. 2 may illustrate the drive train 106 of FIG. 1 for an EV in further detail. It will be appreciated that components of the e-drive 200 having substantially similar function to components of the drive train 106 may be labeled with corresponding numbers, prefixed with a “2” instead of a “1”.

Turning to FIG. 2, it shows a schematic of the drive 200. According to the exemplary embodiment shown in FIG. 2, a drive system for a vehicle, shown as drive 200, includes the engine 112, the electric machine 114, a transmission 30, and an axle 208 including a differential assembly 210 with one or more power takeoff (PTO) devices. The drive 200 may be driven by electric machine 114, and therein may be additionally and alternatively referred to as the e-drive 200. The transmission 30 may be an example of transmission 108 of FIG. 1. The axle 208 may be one of the axles 104 of FIG. 1. One of the final drives 110 of FIG. 1 may include the differential assembly 210. The drive 200 may also include a first PTO 226, a second PTO 228, and/or a third PTO 230.

For a first example embodiment of the drive train 106, the engine 112 may drivingly couple the transmission 30. For a second example of the drive train 106, the electric machine 114 may drivingly couple the transmission 30. For a third example embodiment of the drive train 106, the engine 112 and electric machine 114 may drivingly couple the transmission 30. The engine 112 may input rotational energy via torque and drivingly couple to the transmission 30 via a first input 212. The electric machine 114 may input rotational energy via torque and drivingly couple to the transmission 30 via a second input 214. The transmission 30 may transfer rotational energy via torque and drivingly couple to the axle 208 via a first output 216. The first output 216 may transmit rotational energy via torque and drivingly couple to the differential assembly 210.

For an example of the drive 200, the transmission 30 may drivingly couple and transfer torque to the first PTO 226. The transmission 30 may drivingly couple and transfer torque to the first PTO 226 via a second output 232, such as via rigidly coupling a rotational element, such as a gear, of the first PTO 226. Another example of the drive 200, the transmission 30 may drivingly couple and transfer torque to the second PTO 228. The transmission 30 may drivingly couple and transfer torque to the second PTO 228 via a third output 234, such as via rigidly coupling a rotational element, such as a gear, of the second PTO 228. For another example of the drive 200, the transmission 30 may drivingly couple and transfer torque to the first PTO 226 and the second PTO 228. More specifically the first PTO 226 and the second PTO 228 may drivingly couple to different gearsets of the transmission 30, where each gearset of the different gearsets has a different effective diameter and ratio. The first PTO 226 and/or second PTO 228 may be driven by one or more movers, such as the engine 112 and/or the electric machine 114, via the transmission 30 and the gearsets drivingly coupled therein. Likewise, a PTO assembly, such as the first PTO 226, may be directly and drivingly coupled to an input of the drive train 106, such that the input drives the PTO assembly without transfer of torque to via a gearset or another reduction set of the transmission. For example, a PTO assembly may drivingly couple and receive torque from a first input 212 or the second input 214.

For aforementioned examples or other examples, the axle 208 may drivingly couple and transfer torque to the third PTO 230. The axle 208 may drivingly couple and transfer torque to the third PTO 230 via a fourth output 236. The fourth output 236 may drivingly couple and transfer torque between the differential assembly 210 and the third PTO 230.

The transmission 30 may include a differential assembly. The differential assembly may drivingly couple one or more of the PTO assemblies, such as the first PTO 226 and/or the second PTO 228. For an alternate example, the transmission 30 may include differential assembly 210.

The first PTO 226, the second PTO 228, and/or the third PTO 230 may physically couple and have surface sharing contact with components of the axle 208, such as the differential assembly 210. Likewise, the first PTO 226, the second PTO 228, and/or the third PTO 230 may physically couple and have surface sharing contact with the transmission 30, and more specifically a housing of the transmission 30.

A set of reference axes 301 are provided for comparison between views shown in FIGS. 3-5. The reference axes 301 indicate a y-axis, an x-axis, and a z-axis. In one example, the z-axis may be parallel with a direction of gravity and the x-y plane may be parallel with a horizontal plane that a PTO assembly 312 may rest upon. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

Turning to FIG. 3, it shows a first view 300 of a PTO assembly 312. The first view 300 is a sectional view of the PTO assembly 312. The first view 300 shows a plurality of axes including a first axis 304, a second axis 306, and a third axis 308. The first axis 304, the second axis 306, and the third axis 308 may be longitudinal axes. Likewise, the first axis 304, the second axis 306, and the third axis 308 may be rotational axes, where rotation elements of the PTO assembly 312 may rotate around each of the respective axes. The PTO assembly 312 may be included by a PTO, such as the first PTO 226, the second PTO 228, or the third PTO 230 of FIG. 2.

The PTO assembly 312 may be divided by a first line 314, line A-A. The first line 314 may be perpendicular to the first and third axes 304, 308. The first line 314 and may be vertical relative to the z axis of the reference axes 301. A sectional view of the first line 314 may be taken on the first line 314, where the sectional view may be a perspective of a plane parallel with a plane formed on the y and z axes that includes the first line 314.

The PTO assembly 312 is a PTO unit that may be part of a housing 322 and include a gearset 324. The PTO assembly 312 and therein the PTO unit may be a gearbox. The gearset 324 may be housed in a first cavity 326 of the housing 322. The first cavity 326 is a first internal space of the housing 322 and, more specifically, is an internal space of the PTO assembly 312 and PTO unit thereof. The housing 322 and the first cavity 326 may include a sump section 328. The sump section 328 may collect lubricant from the gearset 324. Said in another way the sump section 328 may form a lubricant sump, such as an oil sump, for the PTO assembly 312 and the first cavity 326.

The gearset 324 may include a carrier 332 and a plurality of gears, where the plurality of gears may be supported by the carrier 332. The gears of the gearset 324 may include a first gear 334, a second gear 336, and a third gear 338. The first gear 334, the second gear 336, and the third gear 338 may be coupled to and supported by the carrier 332. When supported by the carrier 332, the first gear 334 may rotate/spin about the first axis 304. When supported by the carrier 332, the second gear 336 may rotate/spin about the second axis 306. When supported by the carrier 332, the third gear 338 may rotate/spin about the third axis 308.

A first coupling 342 and a second coupling 344 may couple the first gear 334 to the carrier 332. The first coupling 342 and second coupling 344 may support the second coupling 344, where the second coupling 344 may rotate freely when supported via the first and second couplings 342, 344.

A third coupling 346 may couple the third gear 338 to the carrier 332. The third coupling 346 may support the third gear 338, where the third gear 338 may rotate freely when supported via the third coupling 346.

The baffle assembly 340 may include one or more baffles that are positioned adjacent a rotating gear of the gears 334, 336, 338. The baffle assembly 340 may include at least a baffle adjacent to the first gear 334 blocking lubricant splashed there from and guiding the lubricant passively toward other portions of the baffle assembly 340. The one or more baffles of the baffle assembly 340 may be positioned around the first gear 334, for example the baffle or baffles may be positioned such that one or more features of the baffle(s) curve radially around the first gear 334. Further, the entirety of the baffle or baffles of the baffle assembly 340 may be positioned to curve radially around the first gear 334.

For example, the baffle assembly 340 may include a first baffle 348 and a second baffle 350. The first baffle 348 may be positioned opposite the second baffle 350. The first baffle 348 and the second baffle 350 may each be positioned to curve radially about the first gear 334. Lubricant from the first gear 334 may be splashed onto and caught by the first baffle 348 and the second baffle 350. The first baffle 348 and the second baffle 350 may direct fluid splashed thereon passively, such as in a downward direction via the force of gravity. It is to be appreciated that the first baffle 348 and the second baffle 350 may be part of a larger unitary structure, such as if the baffle assembly 340 is a unitary structure. If part of a larger unitary structure, the first baffle 348 and the second baffle 350 may be considered features that are part of a larger and unitary baffle.

The baffle assembly 340 includes a structure that may be referred to collectively as a funnel that comprises a funnel section 352, a heat exchanger section 354, a first mounting section 358, and a second mounting section 360. The funnel and more specifically the funnel section 352 may be a lubricant funnel that directs lubricant toward the sump section 328. More specifically, the funnel and the funnel section 352 therein may be an oil funnel directing oil toward the sump section 328. The funnel section 352 may be a curved structure in shape, such as partially circular or partially elliptical in shape. The first mounting section 358 and second mounting section 360 may be physically coupled to or be connected to the funnel section 352. The first mounting section 358 may be positioned opposite the second mounting section 360 with respect the funnel section 352. The first mounting section 358 may mirror the second mounting section 360. Baffles of the baffle assembly 340, such as the first baffle 348 and the second baffle 350 may rigidly couple and be connected to other features of the baffle assembly 340, such as the funnel section 352 and/or heat exchanger section 354. The first baffle 348 and the second baffle 350 may be connected to the funnel section 352, such as to have continuous surfaces, curvature, and a shape with the funnel section 352. The assembly 340 may be or comprise a unitary structure, where the unitary structure includes first baffle 348, the second baffle 350, the funnel section 352, the heat exchanger section 354, the first mounting section 358, and the second mounting section 360.

A plurality of heat exchange elements, may be positioned within and superimposed with the area of the heat exchanger section 354. For an example, there may be a plurality of first fins 356 part of a larger heat exchanger super imposed with the area of the heat exchanger section 354. The first fins 356 may be separated from the heat exchanger section 354 via a threshold of distance. Alternatively, the first fins 356 may contact the heat exchanger section 354. The heat exchanger that includes the first fins 356 also includes a plurality of first channels 357. Each of the first channels 357 may be sandwiched between a pair of the first fins 356. The funnel section 352 may be positioned about the first gear 334, such as around the first gear 334. The heat exchanger section 354 may be positioned below the first gear 334. The heat exchanger section 354 may extend from the carrier 332 to below the carrier 332 and toward the sump section 328. Likewise, each of the first fins 356 may be oriented with the heat exchanger section 354 to extend from the funnel section 352 toward the sump section 328.

For an example, at least a mounting section of the baffle assembly 340 fastens to the housing 322 to rigidly couple thereto. A plurality of first fasteners 362 may fasten the first mounting section 358 and the second mounting section 360 to the carrier 332. The first fasteners may also fasten the first mounting section 358 to the first coupling 342 and the second mounting section 360 to the second coupling 344. A plurality of second fasteners 364 may fasten the first coupling 342 to the carrier 332. A plurality of third fasteners 366 may fasten the second coupling 344 to the carrier 332. A plurality of fourth fasteners 368 may fasten the third coupling 346 to the carrier 332. As shown in FIG. 3, the baffle assembly 340 is fastened to the housing 322 via the first mounting section 358 and the second mounting section 360.

It is to be appreciated, that a system of or comprising the PTO assembly 312 may lack a pump dedicated to direct lubricant, such as oil, to the gears of the PTO assembly 312 (e.g., the first gear 334 the second gear 336, and the third gear 338), the funnel, or other components of the PTO assembly. There may be a pump to direct lubricant to other components to the system, such as rotating elements of an axle or a transmission before being dripped and funneled to the gears. It is also to be appreciated that the system of and/or the system including the PTO assembly 312 may lack or have a reduced quantity of a radiators, with the with the baffle assembly 340 being used in place of at least a radiator. Oil filter(s), and/or other filters for cleaning lubricant (e.g., one or more of a lubricant filter) are absent between the gears of the PTO assembly, the components and features of the baffle assembly 340, and the sump section 328. The system may therein reduce the quantity of oil filters used by the PTO assembly 312 and a vehicle, such as the vehicle 100 of FIG. 1. For an example, oil filters and filters from lubricant may be removed from use in their entirety from the PTO assembly 312. The reduction or elimination of filters from use in the PTO assembly 312 reduces the amount and frequency of oil filter and other liquid fluid filter changes for the vehicle, and therein may reduce the maintenance time and quantity of parts to be replaced during maintenance of the PTO assembly 312.

In addition to the first baffle 348 and the second baffle 350 of the baffle assembly, the PTO assembly 312 may include other baffles adjacent to rotating gears, such as a third baffle 370. The third baffle 370 may be positioned around the third gear 338. For example, the third baffle 370 may be positioned and curve radially or part radially around the third gear 338. Lubricant from the third gear 338 may be splashed onto and caught by the third baffle 370. The third baffle 370 may direct fluid splashed thereon passively, such as in a downward direction via the force of gravity. The third baffle 370 may direct lubricant toward the first gear 334 and the baffle assembly 340. The baffle assembly 340 and other baffles of the assembly may therein enable passive transport of lubricant toward the first fins 356 and/or other heat exchange elements of a heat exchanger.

Turning to FIG. 4, it shows the first view 300 of the PTO assembly 312, where a lubricant 432 coats and lubricates the gearset 324 and has collected in the sump section 328.

Lubricant 432 may follow a flow path represented by a plurality of arrows 452 comprised of dashed lines through the gearset 324 and the cavity 326 to the sump section 328. The arrows 452 show the funnel section 352 may collect lubricant from the gears of the gearset 324 specifically the first gear 334. The heat exchanger section 354 may collect lubricant from the funnel section 352.

A plurality of droplets 456 of lubricant 432 may be splashed throughout the first cavity 326 from the gears, such as from the first gear 334, the second gear 336, and the third gear 338, and turbulence at a fluid surface 454 of lubricant 432 housed via the sump section 328. The droplets 456 are shown above the fluid surface 454. Likewise, there are a plurality of dots 458 representing turbulence and other movement of lubricant below the fluid surface 454. The droplets 456 and dots 458 shown in FIG. 4 may be recorded and estimated via a computational fluid dynamic (CFD) analysis technique of the PTO assembly 312.

Baffles of the PTO assembly 312 may prevent and/or reduce the quantity of droplets 456 splashed from gears of the gearset 324 to the volume of the cavity 326. For example, the first baffle 348 and second baffle 350 may reduce the quantity of droplets 456 splashed from the first gear 334 and other gears of the gearset 324 to the volume of the cavity 326 around the gearset 324 and outward from the first and second baffles 348, 350. Droplets 456 from the first gear 334 may accumulates on and coat the first and second baffles 348, 350. Likewise, the third baffle 370 may reduce the quantity of droplets 456 splashed from the third gear 338 and other gears of the gearset 324 to the volume of the cavity 326 around the gearset 324 and outward from the third baffle 370. Droplets 456 from the third gear 338 may accumulates on and coat the third baffle 370. Further, the heat exchanger section 354 may reduce the quantity of droplets 456 splashed via the sump section 328, via reducing the turbulence from of lubricant 432 directed downward into the sump. A plurality of surfaces and walls of the heat exchanger section 354 and the first fins 356 may block and neutralize waves and other sources of sheering from lubricant entering the sump section 328 via the baffle assembly 340. The baffle assembly 340 may therein reduce the quantity of dots 458.

The features of the baffle assembly 340, including the baffle(s) 348, 350 around a gear and the heat exchanger section 354, may force the lubricant flow to pass through the first fins 356 and contact a conductive plate connected or physically coupled thereto. The first fins 356 and the conductive plate are part of a heat exchanger, such as a heat sink. The heat exchanger section 354 may be positioned around the first fins 356 other portions of the heat exchanger coupled thereto, such as the conductive plate of the heat exchanger. Likewise, the concentration relative to air, volumetric flow rate, and speed of oil or other lubricant directed through the first fins 356 and against the conductive plate may be increased. In this manner the increased speed of the oil moving around the heat sink or other heat exchanger increases the overall heat exchange coefficient, making the heat exchanger that comprises the first fins 356 and the conductive plate able to transmit more power.

Turning to FIG. 5, it shows a second view 500 of an axle assembly 510 that may physically couple the PTO assembly 312 and include a differential assembly 512. The axle assembly 510 may be or part of an axle or axle system, such as one of the axles 104 of FIG. 1. The second view 500 may be a sectional view of the PTO assembly 312 and the assembly 510 with respect to the y-axis of the reference axes 301. The second view 500 is taken on the first line 314 of FIG. 3. The PTO assembly 312 and the assembly 510 may have a first side 504 and a second side 506. The PTO assembly 312 may include the first side 504. The differential assembly 512 includes the second side 506. The axle assembly 510 includes a fourth axis 508 and a fifth axis 509. The fourth axis 508 and fifth axis 509 may be rotational axes. The fourth axis 508 may be longitudinal and parallel with the first axis 304 and the third axis 308. The fifth axis 509 may be lateral, where the fifth axis 509 may be parallel with the x-axis of the reference axes 301.

The PTO assembly 312 may be divided by a second line 502, line B-B. The second line 502 may be perpendicular to the first axis 304, third axis 308, and the fourth axis 508. The second line 502 and may be vertical relative to the z-axis of the reference axes 301. The second line 502 may be a sectional plane line, and first view 300 of FIG. 3 may be taken on the second line 502. The first view 300 is taken on a sectional plane that includes the second line 502, where the sectional plane is parallel with a plane formed by the x-axis and z-axe of the reference axes 301. The first view 300 is from a view point in the positive direction to the second line 502 and the sectional plane with respect to the y-axis of the reference axes 301.

The axle assembly 510 may be divided by a third line 503, line C-C. The third line 503 may be perpendicular to the first axis 304, third axis 308, and the fourth axis 508. The third line 503 and may be vertical relative to the z-axis of the reference axes 301. The third line 503 may be a sectional plane line, and a sectional view may be taken on the third line 503. The first view 300 is taken on a sectional plane that includes the third line 503, where the sectional plane is parallel with a plane formed by the x-axis and z-axe of the reference axes 301. The first view 300 is from a view point in the positive direction to the third line 503 and the sectional plane with respect to the y-axis of the reference axes 301.

Portions of the housing 322 and a second housing component 514 may be part of the axle assembly 510. The housing 322 and the second housing component 514 may therein be axle housing or form an axle housing when coupled together there around other components of the axle assembly 510. One of the final drives 110 of FIG. 1 may include the differential assembly 512. The differential assembly 210 of FIG. 2 may be or include the differential assembly 512. The second housing component 514 may be a bell. The second housing component 514 may physically couple the housing 322, such as via fastening via fasteners. The second housing component 514 and the housing 322 may include a second cavity 516. The second cavity 516 may be enclosed by the second housing component 514 and the housing 322, such as when the second housing component 514 physically couples the housing 322. The second cavity 516 may be part of or include a second internal space of an axle or axle system, where the axle assembly 510 is an axle system comprising the axle. The housing 322 may include a wall 515. The wall 515 may be between first cavity 326 and the second cavity 516. The second cavity 516 may house the differential assembly 512.

Fluid communication may be prevented between the PTO assembly 312 and the axle of the axle assembly 510. Said in another way, flow of lubricant, such as oil, may be prevented between a PTO unit and the axle of the axle assembly 510. The wall 515 may prevent flow of lubricant between the first cavity 326 and the second cavity 516.

A third housing component 518 may physically couple the housing 322. The third housing component 518 may be a bell. The housing 322 and the third housing component 518 may enclose the first cavity 326. The third housing component 518 may physically couple a first cover 520. The first cover 520 may fluidly seal the first cavity 326, preventing fluid communication between the first cavity 326 and the exterior 310.

The second view 500 shows the PTO assembly 312 may include a first shaft 522 and a second shaft 524. The first shaft 522 may support the first gear 334. The second shaft 524 may support the second gear 336. The first gear 334 may rotationally couple the first shaft 522, such that the first gear 334 may rotate with and be driven by the first shaft 522. The second gear 336 may rotationally couple the second shaft 524, such that the second gear 336 may rotate with and be driven by the second shaft 524. The second shaft 524 may rotationally couple a third shaft 526. The third shaft 526 may be centered on the third axis 308. A portion of the third shaft 526 may be housed via the housing 322 and the second housing component 514. Another portion of the third shaft 526 may extend through the second housing component 514 to the exterior 310. The third shaft 526 may be a PTO shaft, and may drivingly couple an implement driven by the PTO assembly 312. The third shaft 526 may rotate/spin about the third axis 308, such as when rotationally coupled to the second shaft 524.

The differential assembly 512 may include a fourth baffle 528, a differential 532, a first side gear 534, and an input 536, visible via the second view 500. The second cavity 516 may also include a portion of a heat exchanger 530. The heat exchanger 530 may extend through the wall 515, having components housed in the first cavity 326 and components housed in the second cavity 516. The second housing component 514 may include a shell 538. The shell 538 may house and support portions of the input 536. The input 536 may drivingly couple to gears and other rotational elements of the differential assembly 512, such as a ring gear. The input 536 may supply the differential assembly 512 with torque. Torque may be distributed to half shafts of the axle, via component of the differential assembly 512, such as via the first side gear 534. The differential 532 physically and rotationally couple to the first side gear 534. The first side gear 534 may rotationally couple to a rotational element of the axle, such as an axle half shaft. The first side gear 534 may receive a complementary rotational element, such as an axle half shaft, via a passage 535 of the first side gear 534. For clarification, a complementary rotational element may rotationally couples to a referenced part, such as via rigidly coupling. The passage 535 may have fastening features extending there-toward, such as threading, splines or teeth, complementary to the complementary rotational element. For further clarification, fastening features complementary to a complementary rotational element may be being fit and couple to the rotational element. When meshed, the fastening features of the passage 535 and fastening features of the complementary rotational element may physically and drivingly couple the first side gear 534 to the complementary rotational element.

The second housing component 514 may include a first passage 541. The first passage 541 may be centered on the fourth axis 508, such that the first passage 541 may be radially about the fourth axis 508. The shell 538 may include a collar 540. The collar 540 may be about the first passage 541, such as around the first passage 541. For an example, the collar 540 may circumferentially surround the first passage 541. In addition to the first passage 541, the second housing component 514 may include a fluid channel 566. The shell 538 may include the fluid channel 566. The fluid channel 566 may place the second cavity 516 in fluid communication with the fluid channel 566. The fluid channel 566 may direct fluid from the second cavity 516 to the first passage 541. For example, lubricant flung or splashed from other components of the differential assembly 512 from the input 536, may be collected from the second cavity 516 via the fluid channel 566 and distributed by the fluid channel 566 to the first passage 541. The first passage 541 may receive the input 536. The input 536 may extend through the second housing component 514 via the first passage 541, having a portion housed by the second cavity 516 and a portion in the exterior 310. A first end of the input 536 may be housed in the second cavity 516, and a second end of the input 536 may extend into and be surrounded by the exterior 310, where the second end is opposite the first end.

A first coupling 542 may physically couple the input 536. The first coupling 542 may be positioned to couple a portion of the input 536 that may be surrounded by the exterior 310, such as the second end. The first coupling 542 may physically and rotationally couple to a rotational element, such as a shaft, such as a driveshaft. The rotational element that may physically and rotationally couple to the input 536 via the first coupling 542, may drive the input 536. The rotational element and input 536 may be driven as a single rotational element. For example, the first coupling 542 may couple a driveshaft of the one or more driveshafts 136 of FIG. 1.

A second coupling 544 may physically couple the third shaft 526. The second coupling 544 may be positioned to couple a portion of the third shaft 526 extending out of the second housing component 514 and surrounded by the exterior 310. The second coupling 544 may physically and rotationally couple to a rotational element, such as an implement of the PTO. The rotational element that may physically and rotationally couple to the third shaft 526 via the second coupling 544, may be driven by third shaft 526. The rotational element and the third shaft 526 may be driven as a single rotational element.

The first and second shafts 522, 524 may be supported by a plurality of bearings, allowing the first and second shafts 522, 524 to rotate freely of the housing 322. For example, the first shaft 522 may be supported by a plurality of first bearings 546 and a plurality of second bearings 548. The first bearings 546 and second bearings 548 may be positioned radially about the first shaft 522, and the first bearings 546 and the second bearings 548 may be sandwiched radially between features of the housing 322 and the first shaft 522. The second shaft 524 may be supported by a plurality of third bearings 550 and a plurality of fourth bearings 552. The third bearings 550 and fourth bearings 552 may be positioned radially about the second shaft 524. The third bearings 550 and the fourth bearings 552 may be sandwiched radially between features of the housing 322 and the second shaft 524.

The third shaft 526 may be supported by a plurality of fifth bearings 556, allowing the third shaft 526 to rotate freely of the housing 322 and the second housing component 514. A plurality of fifth bearings 556 may be positioned radially about the third shaft 526. The fifth bearings 556 may be sandwiched radially between features of the second housing component 514 and third shaft 526. The third shaft 526 may also physically couple and be supported by the second shaft 524. The second shaft 524 may include, or physically and rigidly couple to a socket 554. The socket 554 may support the third shaft 526, where the socket 554 may receive and be positioned radially about the at least a portion of the third shaft 526. When received by the socket 554, the third shaft 526 may rotationally couple and be driven by the second shaft 524.

The housing 322 may have a second passage 558 and a fourth passage 568. The second passage 558 and fourth passage 568 may be through passages placing the first cavity 326 in communication with the second cavity 516. The second passage 558 and fourth passage 568 may extend through the wall 515. In addition to the first passage 541, the second housing component 514 may have a third passage 560. The third passage 560 may be a through passage, such as a through hole. The third passage 560 may place the second cavity 516 in communication with the exterior 310. The second passage 558 may receive the second shaft 524 and the third shaft 526. The second passage 558 may receive the socket 554, where the socket 554 may receive and couple to third shaft 526. The second passage 558 may be about the socket 554, such as to be as radially about the socket 554. The third passage 560 may receive the third shaft 526. The fifth bearings 556 may be sandwiched radially between a surface of the third passage 560 and the third shaft 526. The third shaft 526 may extend through the third passage 560 to the exterior 310.

A plurality of sixth bearings 562 and a plurality of seventh bearings 564 may support the input 536, allowing the input 536 to rotate freely of the housing 322 and the second housing component 514. The plurality of sixth bearings 562 and seventh bearings 564 may be positioned radially about the input 536. The sixth bearings 562 and seventh bearings 564 may be sandwiched radially between the inner surfaces of the first passage 541 and the input 536.

The heat exchanger 530 may be a conductive heat exchanger, such as a heat sink. The heat exchanger may 530 be a plate or another structure that includes plurality of features physically coupled or molded to the structure, such that features may conduct thermal energy to the plate of the heat exchanger 530. The heat exchanger 530 includes a plurality of heat exchange elements, such as the first fins 356, that may increase the surface area of the heat exchanger 530. In addition to the first fins 356, the heat exchanger 530 may have a platform 570 and a plurality of second fins 572. The second fins 572 may be heat exchange elements as the first fins 356. The platform 570 may support the first and second fins 356, 572, where the first and second fins 356, 572 physically couple to opposite sides of the platform 570. The platform 570 may comprise a thermally conductive material and may be a plate. The platform 570 may therein be a conductive plate for thermal energy to be conducted therethrough.

The heat exchanger 530 may have a plurality of first heat exchange elements connected to and extending from a first side of the heat exchanger and a plurality of second heat exchange elements connected to and extending from a second side of the heat exchanger 530. For example, the first fins 356 may be fixed to a first surface and the second fins 572 may be fixed to a second surface of the platform 570, where the first surface and the second surface are on opposite sides of the platform 570. The first fins 356 are on a surface of the platform 570 that may be closest to first side 504. The second fins 572 are on another surface of the platform 570 that may be closest to the second side 506. The heat exchanger 530 may physically couple the wall 515, such that the heat exchanger 530 is fixed to the housing 322. The heat exchanger 530 may be positioned and mounted to the wall 515 such that features of the heat exchanger 530 may extend through the fourth passage 568. Features of the heat exchanger 530 may be positioned to be housed by the first cavity 326 via extending through the fourth passage 568. The wall 515 may have a surface, such as a surface 574, via which the heat exchanger 530 may physically couple. For example, the heat exchanger 530 may be mounted to the wall 515 via mounting the platform 570. When mounted to the wall 515, the platform 570 may be mounted and fixed to surface 574. The first fins 356 may extend through the fourth passage 568 into the first cavity 326.

The arrows 452 may be used to show in part a method of removing thermal energy from a PTO assembly. A first example of the method may comprise splashing lubricant of a first temperature from at least gear, such as the first gear 334, to a baffle adjacent to the gear. The method continues by accumulating lubricant on surfaces of the baffle and directing lubricant passively from the baffle to a funnel. The method continues by directing lubricant collected by the funnel passively from the funnel to the heat exchanger 530. The method continues by coating a plurality of heat exchange elements of the heat exchanger 530 of the PTO assembly with lubricant. The heat exchange elements are the first fins 356, for example. The method continues via cooling the lubricant via the heat exchanger. The heat exchanger cools the lubricant via removing thermal energy therefrom via the heat exchanger elements, before the lubricant that coats the heat exchanger elements drips or passively enters the sump section 328 via other means from the heat exchange elements. The method continues up-taking thermal energy from the lubricant to the heat exchanger 530 via the heat exchange elements, such as the first fins 356. The method continues by directing thermal energy from the lubricant across the heat exchanger between the heat exchange elements and a plurality of other heat exchange elements. Said in another way, heat may be transferred via heat exchanger 530 between the first heat exchange elements and the second heat exchange elements. For example, heat may be transferred from the first fins 356 to the second fins 572 and through the platform 570. The method ends with thermal energy being removed from the second fins 572.

Additionally, or alternatively the method may be completed in reverse, such as if the temperature of the sump section 328 and lubricant therein were cooler than the second cavity and the fluid housed therein. For this alternate example, the alternate method begins with thermal energy accumulating in the other heat exchange elements (e.g., the second fins 572). The alternate method continues, by directing thermal energy accumulated via the other heat exchange elements through the heat exchanger 530 and to the heat exchange elements (e.g., the first fins 356) lubricant across the heat exchanger 530 between the other heat exchange elements and the heat exchange elements housed via the sump section 328 and extending toward the funnel section 352. The method warms the lubricant coating the heat exchange elements via contact with the heat exchange elements and the thermal energy accumulated and transported therein. The heat exchanger 530 therein warms the lubricant, before the lubricant drips or passively enters the sump section 328 via other means from the heat exchange elements.

Thermal energy may be driven through the components of the heat exchanger 530 via conduction. Thermal energy may be added and removed from the heat exchanger 530 via conduction, convection, and radiation, where convection of lubricant or other fluid, such as air, may remove thermal energy from or add thermal energy to the heat exchanger 530.

A second example of the method may also include directing lubricant of a second temperature passively toward the other heat exchange elements, and coating the other heat exchange elements of the heat exchanger 530 with lubricant of the second temperature. The second temperature is different from the first temperature. The lubricant of the second temperature may be splashed or dripped from components of the differential assembly 512, such as the differential 532. For a first example, the second temperature may be greater than the first temperature, and thermal energy may be transferred from the second fins 572 across the heat exchanger to the first fins 356. The heat exchanger 530 may heat lubricant coating the first fins 356. The heat exchanger 530 may therein heat lubricant collected in the sump section. For a second example, the second temperature may be less than the first temperature, and the heat exchanger 530 may be cooled by fluid from the second cavity 516, cooling the second fins 572. Thermal energy may be drawn away from the first fins 356 across the heat exchanger 530, and the first fins 356 may cool lubricant coated thereto.

Turning to FIG. 6, it shows a third view 600 of the axle assembly 510. The third view 600 is a sectional view of the axle assembly 510 with respect to the y-axis of the reference axes 301. The third view 600 is taken on the third line 503 of FIG. 5.

The housing 322 may have a first axle tube 622 and a second axle tube 624. The first axle tube 622 may receive and curve around a first axle half shaft. The second axle tube 624 may receive and curve around a second axle half shaft. The second cavity 516 is located between the first axle tube 622 and the second axle tube 624. The differential assembly 512 includes a ring gear 630, a second side gear 632, and a plurality of differential gears 636. The second side gear 632 is opposite the ring gear 630 and the fourth baffle 528 from the first side gear 534 and the differential 532. The differential 532 and the first side gear 534 may be positioned nearest to the first axle tube 622 from the second axle tube 624. The second side gear 632 may be positioned nearest to the second axle tube 624 from the first axle tube 622. The first side gear 534 and the second side gear 632 may mesh and drivingly couple to the ring gear 630 via the differential gears 636. The second side gear 632 may have a passage 634. The second side gear 632 may receive a complementary rotational element, such as an axle half shaft, via the passage 634. The passage 634 may have fastening features, such as threading, splines or teeth, complementary to the complementary rotational element. When meshed, the fastening features of the passage 634 and the fastening features of the complementary rotational element may physically and drivingly couple the second side gear 632 to the complementary rotational element. A differential carrier 638 may support and couple to the differential 532.

The heat exchanger 530 has a plurality of second channels 652, where the second channels 652 may be gaps between the second fins 572. For an example each of the second channels 652 may be sandwiched between a pair of the second fins 572. A plurality of fasteners 654 may be complementary to heat exchanger 530. The fasteners 654 may extend through complementary holes of the platform 570 and complementary holes of the wall 515 of FIG. 5 to fasten and mount the heat exchanger 530 to the wall 515.

A plurality of bearings may support the gears and other rotational elements of the differential assembly 512. For example, the differential assembly 512 may be supported by one or more of a plurality of eighth bearings 672, one or more of a plurality of ninth bearings 674, and one or more of a plurality of tenth bearings 676. The eighth bearings 672 may be positioned around and support the differential 532. The ninth bearings 674 may be positioned around and support the ring gear 630.

Turning to FIG. 7, it shows a fourth view 700 of the heat exchanger 530. The fourth view 700 is a perspective view and a side view of the heat exchanger 530, where the heat exchanger 530 is separated from other components of the PTO assembly 312 and the axle assembly 510 of FIGS. 3-5. The fourth view 700 includes an axis 702. The axis 702 may be a longitudinal axis parallel with the y-axis of the reference axes 301. The heat exchanger 530 may be centered on the axis 702.

As shown in FIG. 7, the heat exchanger 530 is a heat sink. The heat exchanger 530 may have a first side 704 and a second side 706. The first side 704 may be opposite the second side 706, where the first side 704 is separated from the second side 706 by the platform 570. The first side 704 may be a funnel side and PTO side of the heat exchanger 530, where the first side 704 may face the baffle assembly 340 and PTO assembly 312 of FIGS. 3-5. The baffle assembly 340 includes the funnel of the PTO assembly 312. The second side 706 may be differential side, where the second side 706 may be enclosed by the second cavity 516 and face the differential assembly 512.

The platform 570 may have a first surface 722 and a second surface 724. The first surface 722 and the second surface 724 may be flat and normal to the axis 702. The second surface 724 is opposite the first surface 722, such that the first surface 722 is on the first side 704 and the second surface 724 is on the second side 706. The first fins 356 may extend away from the first surface 722. The first fins 356 may physically couple and/or be connected to the first surface 722. The second fins 572 may extend away from the second surface 724. The second fins 572 may physically couple and/or be connected to the second surface 724.

In addition to the first and second fins 356, 572, the heat exchanger 530 may have a plurality of third fins 732. The third fins 732 and second fins 572 may be coupled to a common side of the heat exchanger 530. The third fins 732 may extend away from the second surface 724. The third fins 732 may physically couple and/or be connected to the second surface 724. The first fins 356, the second fins 572, and the third fins 732 may be a first length 734, a second length 736, and a third length 738, respectively.

Each of the first fins 356 may be separated by a first gap 740. Each of the second fins 572 may be separated by a second gap 742 or a third gap 744. There is a plurality of first gaps 740, where each of the first gaps 740 may be a distance between each of the first fins 356. The first gaps 740 may be the width of the first channels 357 of FIG. 3. Alternatively, the first gaps 740 may be greater than and include the width of the first channels 357. Each of the second fins 572 may be separated by a second gap 742 or a third gap 744. There is a plurality of second gaps 742. Each of the second gaps 742 may be a distance between each of the second fins 572, where there is not a fin of the third fins 732 between the second fins 572. There is a plurality of third gaps 744. Each of the third gaps 744 may be a distance between each of the second fins 572, where a fin of the third fins 732 is between the second fins 572. The second side 706 may have a plurality second channels 746 a third channels 748. Each of the second channels 746 may be between two of the second fins 572 where there is not a fin of the third fins 732 between the pair of the second fins 572. Each of the third channels 748 may be between two of the second fins 572 where a fin of the third fins 732 is between the pair of the second fins 572. Each of the third channels 748 may be divided by a fin of the third fins 732. Said in another way, a third fin of the third fins 732 may be centered and extend along each of the third channels 748. The second gap 742 and third gap 744 may be the widths of the second channels 746 and the third channels 748, respectively. The distance the third gap 744 may be larger than the distance of the second gap 742.

The platform may have a plurality of first holes 752. The first holes 752 may be through holes, extending through the platform 570 from the first side 704 to the second side 706. The holes 752 are complementary to the fasteners 654 of FIG. 6, where the fasteners 654 may be fit to and extend through the first holes 752. The holes 752 may have a threading complementary to the fasteners 654.

Each of the first fins 356 and the second fins 572 may have a plurality of surfaces. The first fins 356 may each have one or more of a plurality of first surfaces 756. The second fins 572 may each have one or more of a plurality of second surfaces 758. For an example, each of first fins 356 may have two of the first surfaces 756. Each surface of the pair of first surfaces 756 are opposite to one another across their respective fin of the first fins 356. Likewise, for this or other examples, each of second fins 572 may have two of the second surfaces 758. Each surface of the pair of the second surfaces 758 are opposite to one another across their respective fin of the second fins 572. The first and second fins 356, 572 may be corrugated, such as to have a plurality of ridges. The first and second surfaces 756, 758 may be corrugated, such as to have the plurality of ridges. For example, the first surfaces 756 may have a plurality of first ridges 762. The first ridges 762 may extend the first length 734 across the first surfaces 756. For this or another example, the second surface 758 may have a plurality of second ridges 764. The second ridges 764 may extend the second length 736 across the second surfaces 758.

Turning to FIG. 8, it shows a fifth view 800 of the heat exchanger 530. The fifth view 800 is a perspective view and a side view of the heat exchanger 530, where the heat exchanger 530 is separated from other components of the PTO assembly 312 and the axle assembly 510 of FIGS. 3-5.

The heat exchanger 530 may have a plurality of second holes 852. The second holes 852 may be through holes, extending through the platform 570 from the first side 704 to the second side 706. The second holes 852 are complementary to the fasteners 654 of FIG. 6, where the fasteners 654 of may be fit to and extend through the second holes 852. The second holes 852 may have a threading complementary to the fasteners 654. Each of the second holes 852 may be positioned between a pair of the second fins 572 separated via the third gap 744.

The third fins 732 may have a plurality of surfaces. The third fins 732 may each have one or more of a plurality of third surfaces 862. For an example, third fins 732 may have two of the third surfaces 862, where each of the pair of the third surfaces 862 are opposite to one another across their respective fin of the third fins 732. The third fins 732 may be corrugated, such as to have a plurality of ridges. The third surfaces 862 may be corrugated, such as to have the plurality of ridges. For example, the first surfaces 756 may have a plurality of third ridges 864. The third ridges 864 may extend the third length 738 across the third surfaces 862.

It is to be appreciated, that in another representation, the disclosure also provides support for a method of removing thermal energy from a PTO assembly, comprising: splashing lubricant of a first temperature from a gear to a baffle adjacent to the gear, accumulating the lubricant on surfaces of the baffle, directing lubricant passively from the baffle to a funnel, directing lubricant passively from the funnel to a heat exchanger, where the heat exchanger is arranged to extend between the PTO assembly and an internal space housed by an axle assembly, coating a plurality of heat exchange elements of the PTO assembly with lubricant, up-taking thermal energy from the lubricant via conduction, and directing thermal energy from the lubricant across the heat exchanger between the heat exchange elements and a plurality of other heat exchange elements. In a first example of the method comprising directing lubricant of a second temperature passively toward the other heat exchange elements, and coating the other heat exchange elements with lubricant of the second temperature. In a second example of the method, optionally including the first example comprising using oil as lubricant.

It will be appreciated that the configurations and routines disclosed herein are exemplary in nature, and that these specific embodiments are not to be considered in a limiting sense, because numerous variations are possible.

Moreover, unless explicitly stated to the contrary, the terms “first,” “second,” “third,” and the like are not intended to denote any order, position, quantity, or importance, but rather are used merely as labels to distinguish one element from another, different, element. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

1. A system for cooling a power take-off (PTO) unit, comprising:
a heat sink positioned in a lubricant sump of the PTO unit, the lubricant sump of the PTO unit fluidly coupled to an internal space of an axle;
a lubricant funnel positioned to direct lubricant to the heat sink; and
a baffle positioned adjacent a rotating gear of the PTO unit and configured to direct lubricant to the lubricant funnel.

2. The system of claim 1, where the heat sink is positioned to extend through a passage and into a second internal space of the PTO unit and the internal space of the axle, where heat exchange elements of the heat sink are surrounded by the second internal space of the PTO unit and the internal space of the axle, where the second internal space includes the lubricant sump.

3. The system of claim 1, where the baffle and the lubricant funnel are formed as a unitary structure.

4. The system of claim 1, where one or more features of the baffle curve radially around the rotating gear.

5. The system of claim 1, where at least a first mounting section of the baffle fastens to a housing of the PTO unit via a plurality of fasteners extending through the mounting section.

6. The system of claim 5, where the baffle includes a plurality of mounting sections further comprising the first mounting section and a second mounting section on opposite sides of the baffle.

7. The system of claim 1, where the heat sink includes a plurality of first fins and a plurality of second fins, where the first fins extend toward the lubricant funnel and receive lubricant therefrom, and the second fins extend toward a differential assembly and receive lubricant therefrom.

8. The system of claim 1, where the axle drivingly couples to the PTO unit to transmit torque to the PTO unit via an output.

9. The system of claim 1, where a transmission drivingly couples to the axle to transmit torque to the axle.

10. The system of claim 1, where fluid communication is prevented between the PTO unit and the axle.

11. The system of claim 1, where a conductive plate is positioned between a second internal space of a gearbox of the PTO unit and the internal space of the axle.

12. The system of claim 1, where the system is passive and lacks a pump to direct lubricant from the lubricant funnel and/or the heat sink for cooling.

13. The system of claim 1, where a lubricant filter for cleaning lubricant is absent from the system and the PTO unit.

14. A system for an axle assembly, comprising:
an axle;
an axle housing;
a differential assembly, housed by the axle housing;
a power take-off (PTO) unit;
a baffle;
a lubricant funnel; and
a heat sink;
where the heat sink is positioned in a lubricant sump of the PTO unit, the lubricant sump of the PTO unit is fluidly coupled to an internal space of the axle housing;
the lubricant funnel is positioned to direct lubricant to the heat sink; and
the baffle is positioned adjacent a rotating gear of the PTO unit and configured to direct lubricant to the lubricant funnel.

15. The system of claim 14, where a section of the funnel is positioned around a plurality of first heat exchange elements of the heat sink, and lubricant from one or more gears of the PTO unit is directed to coat the first heat exchange elements.

16. The system of claim 15, where lubricant from the differential assembly coats a second heat exchange elements extending into the internal space housing the differential assembly, and the second heat exchange elements are opposite a platform of the heat sink from the first heat exchange elements.

17. The system of claim 16, where the first heat exchange elements and the second heat exchange elements are fins, and the first heat exchange elements are separated via a plurality of first channels, and the second heat exchange elements are separated by a plurality of second channels.

18. A heat exchanger for a vehicle, comprising:
a platform;
a plurality of first fins; and
a plurality of second fins;
where the first fins and the second fins are physically coupled to opposite sides of the platform, the platform is physically coupled to a housing, the first fins are separated by a plurality of first gaps, the second fins are separated via a plurality of second gaps, the heat exchanger is positioned such that a section of a funnel is around and directs lubricant to passively coat the first fins, and the heat exchanger is positioned to passively receive lubricant from an axle assembly.

19. The heat exchanger of claim 18, where the platform is fastened to the housing via a plurality of fasteners to the housing, and the first fins extend through a passage of the housing and a sump of a PTO assembly, and heat is transferred from the PTO assembly to an internal space of the axle assembly.

20. The heat exchanger of claim 19, where the heat exchanger comprises a plurality of third fins, the second fins and the third fins are coupled to a common side of the platform, the third fins are between pairs of the second fins, pairs of second fins opposite the third fins are separated by a plurality of third gaps, where through holes for fasteners extending through the platform are between each of the third gaps.
